(19) United States
(12) Patent Application Publication
(10) Pub. No.: US 2022/0345360 A1
(43) Pub. Date: Oct. 27, 2022

(54) Fault Locating Method, Apparatus And System Based On I2C Communication

(71) Applicant: Inspur Suzhou Intelligent Technology Co., Ltd., Suzhou (CN)

(72) Inventor: Jiale Yan, Suzhou (CN)

(21) Appl. No.: 17/763,481

(22) PCT Filed: Dec. 30, 2019
(86) PCT No.: PCT/CN2019/130019

§ 371 Date: Mar. 24, 2022

(30) Foreign Application Priority Data
Sep. 27, 2019 (CN) 201910926583.3

(51) Int. Cl. H04L 41/0677; H04L 12/40

(52) U.S. Cl. CPC H04L 41/0677; H04L 12/40

(57) ABSTRACT

A fault locating method, apparatus and system based on I2C communication. The system comprises a power supply module, a substrate management controller, a fixture and a processor, wherein the power supply module and the substrate management controller are connected by means of a fixture, and the I2C bus is led out through the fixture and connected to the processor; the processor acquires state data information of the power supply module during the normal I2C communication with the substrate management controller, and converting the data type of the state data information to a data type of a preset format; and when it is detected that a failure has occurred in the power supply module, a failure code is located according to the state data information. A fault occurring during I2C communication between a BMC and a PSU can be located efficiently, and effectively improving the efficiency of fault solving.

### CROSS REFERENCE TO RELATED APPLICATIONS

This application claims priority to Chinese patent application No. 201910926583.3, filed to the CNIPA on Sep. 27, 2019 and entitled “Fault Locating Method, Apparatus and Equipment Based on I2C Communication, and Storage Medium”, the entire contents of which are incorporated herein by reference.

### TECHNICAL FIELD

The present disclosure relates to the technical field of server testing, in particular to a fault locating method, apparatus and system based on I2C communication.

### BACKGROUD

Before being popularized for marketization application, software and hardware products need to be tested, and efficient and accurate testing is crucial to research and development of the whole product and determines the period and cost of product research and development. In the development and debugging process of a BMC (baseboard management controller), the circumstance that the performance of a power supply unit (PSU) is inconsistent in individual debugging and system debugging is inevitably caused by the fact that the BMC performs wrong writing operation on a register of the PSU through an I2C (Inter-Integrated Circuit) bus.

The I2C bus is a bidirectional binary synchronous serial bus configured to connect a microcontroller and peripheral equipment thereof, and only needs two lines (a serial data line (SDA) and a serial clock line (SCL)) to transmit information between apparatuses connected to the bus. When a apparatus on the bus detects that the bus is idle, the apparatus may be used as a host to start transmitting data.

In the I2C debugging test process of the BMC and the PSU, when bug or fault occurs, all codes related to PSU communication are searched from BMC codes in the related technology, and then the codes are analyzed for fault locating. The code searching mode is not targeted, long in consumed time and low in efficiency.

In view of this, how to quickly locate the fault problem generated by the BMC and the PSU in an I2C communication process is a problem needing to be solved by those skilled in the art.

### SUMMARY

An embodiment of the present disclosure provides a fault locating method, apparatus and system based on I2C communication, through which faults generated in a process of I2C communication between a BMC and a PSU can be efficiently located, debugging time is shortened, participating manpower is reduced, and the fault solving efficiency can be efficiently improved.

In order to solve the technical problem, the embodiment of the present disclosure provides the following technical solutions:

One objective of the embodiment of the present disclosure is to provide a fault locating system based on I2C communication, and the fault locating system includes a power supply unit, a baseboard management controller, a jig and a processor; the power supply unit is connected to the baseboard management controller through the jig, and the jig is connected to the processor through an I2C bus; and

the processor is configured to acquire state data information of the power supply unit in a process of normal I2C communication with the baseboard management controller, convert the data type of the state data information into a data type of a preset format, and locate a fault code according to the state data information when it is detected that the power supply unit has a fault.

Optionally, the processor is specifically configured to detect, by monitoring changed state words in the state data information, whether the power supply unit is in a fault state or not.

Optionally, the processor is further configured to package and output the fault code and log information in a corresponding process to a preset path, and back up the fault code at the same time.

Optionally, the processor is further configured to call a pre-stored debug version set to parse the fault code, so as to obtain a corresponding fault type; and the debug version set includes a plurality of debug versions, and each debug version uniquely corresponds to one fault type.

Another objective of the embodiment of the present disclosure is to provide a fault locating method based on I2C communication, applied to a fault locating system that is based on I2C communication and includes a power supply unit, a baseboard management controller, a jig and a processor; the power supply unit is connected to the baseboard management controller through the jig, and the jig is connected to the processor through an I2C bus, and the fault locating method includes:

acquiring state data information of the power supply unit in a process of normal I2C communication with the baseboard management controller;

converting the data type of the state data information into a data type of a preset format; and

locating a fault code according to the state data information when it is detected that the power supply unit has a fault.

Optionally, locating a fault code according to the state data information when it is detected that the power supply unit has a fault includes:

detecting, by monitoring changed state words in the state data information, whether the power supply unit is in a fault state or not.

Optionally, after locating a fault code according to the state data information, the method further includes:

packaging and outputting the fault code and log information in a corresponding process to a preset path, and backing up the fault code at the same time.

Optionally, after locating a fault code according to the state data information, the method further includes:

calling a pre-stored debug version set to parse the fault code to obtain a corresponding fault type; wherein the debug version set includes a plurality of debug versions, and each debug version uniquely corresponds to one fault type.

The embodiment of the present disclosure further provides a fault locating apparatus based on I2C communication, applied to a fault locating system that is based on I2C communication and includes a power supply unit, a baseboard management controller, a jig and a processor; the power supply unit is connected to the baseboard management controller through the jig, and the jig is connected to the processor through an I2C bus, and the fault locating apparatus includes:

a state information acquiring module, configured to acquire state data information of the power supply unit in a process of normal I2C communication with the baseboard management controller;

a data type conversion module, configured to convert the data type of the state data information into a data type of a preset format; and

a fault locating module, configured to locate a fault code according to the state data information when it is detected that the power supply unit has a fault.

Optionally, the fault locating module is a module which detects, by monitoring changed state words in the state data information, whether the power supply unit is in a fault state or not.

The technical solution provided by the present application has the advantages that the power supply unit, the baseboard management controller, the jig and the processor are all connected to the I2C bus, normal communication between the power supply unit and the baseboard management controller is not affected, the state of the power supply unit can further be monitored by the processor on the basis of not affecting communication between the power supply unit and the baseboard management controller, when the power supply unit has a fault, a fault code is located by collecting state data information of the power supply unit, so that a PSU tester can independently analyze a communication fault of the BMC, and a targeted code checking direction is provided for BMC developers, thus, faults generated in the process of I2C communication between the BMC and the PSU are efficiently located, debugging time is shortened, participating manpower is reduced, and the fault solving efficiency can be effectively improved.

In addition, the embodiment of the present disclosure further provides a corresponding implementation method and apparatus for the fault locating system based on I2C communication, the system is further enabled to be more feasible, and the method and apparatus have the corresponding advantages.

It should be understood that both the foregoing general description and the following detailed description are exemplary and explanatory only and are not restrictive of the present disclosure.

### BRIEF DESCRIPTION OF THE DRAWINGS

In order to more clearly illustrate the embodiments of the present disclosure or the technical solutions of the related arts, the drawings used in the description of the embodiments or the related arts will be briefly described below, it is obvious that the drawings in the description below are only some embodiments of the present disclosure, and it is obvious for those skilled in the art that other drawings can be obtained according to the drawings without creative efforts.

FIG. 1 is a structure diagram of a fault locating system based on I2C communication under a specific implementation mode according to an embodiment of the present disclosure;

FIG. 2 is a flowchart of a fault locating method based on I2C communication according to an embodiment of the present disclosure;

FIG. 3 is a flowchart of another fault locating method based on I2C communication according to an embodiment of the present disclosure;

FIG. 4 is a structure diagram of a fault locating apparatus based on I2C communication under a specific implementation mode according to an embodiment of the present disclosure; and

FIG. 5 is a structure diagram of a fault locating apparatus based on I2C communication under another specific implementation mode according to an embodiment of the present disclosure.

### DETAILED DESCRIPTION

In order that those skilled in the art will better understand the solution of the present disclosure, the present disclosure will now be described in further detail with reference to the accompanying drawings and specific implementation modes. It should be apparent that the described embodiments are only some embodiments of the present disclosure, but not all embodiments. All other embodiments, which are obtained by a person of ordinary skill in the art without making any creative effort based on the embodiments in the present disclosure, belong to the scope of protection of the present disclosure.

The terms “first,” “second,” “third,” “fourth,” and the like in the description and claims of the present application and in the foregoing drawings are used for distinguishing between different objects and not necessarily for describing a particular sequential order. Furthermore, the terms “include” and “have,” as well as any variations thereof, are intended to cover a non-exclusive inclusion. For example, a process, method, system, product, or equipment that includes a series of steps or units is not limited to only those listed steps or units but may include other steps or units not listed.

After the technical solutions of the embodiments of the present disclosure are introduced, various non-limiting implementation modes of the present application will be described in detail below.

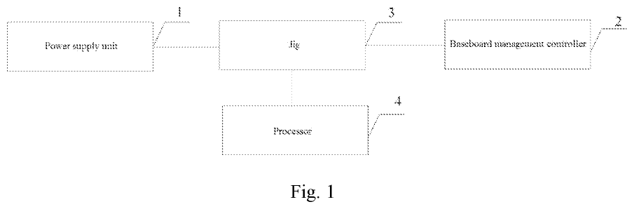

Referring to FIG. 1 firstly, FIG. 1 is a structure frame diagram of a fault locating system based on I2C communication under a specific implementation mode according to an embodiment of the present disclosure, and the embodiment of the present disclosure may include the following content:

the fault locating system based on I2C communication may include a power supply unit 1, a baseboard management controller 2, a jig 3 and a processor 4. The power supply unit 1 is connected to the baseboard management controller 2 through the jig, and the jig 3 leads out an I2C bus, and is connected to the processor 4. The jig 3 may be any testing jig, such as a CRPS jig; the processor 4 may be any hardware equipment capable of executing corresponding functions, such as an upper PC. The jig 3 leads out I2C bus, and the I2C bus may be connected to the upper PC by means of a Microchip PICkit Serial Analyzer, thus, equipment on the bus includes the PSU, the BMC and the upper PC, the state of the power supply unit is monitored in a targeted manner by the upper PC on the basis of not affecting normal work of the BMC, and the PSU debug test of multi-host joint debugging is realized.

Specifically, the processor 4 may be configured to acquire state data information of the power supply unit 1 in a process of normal I2C communication with the baseboard management controller 2, converting the data type of the state data information into a data type of a preset format, and locating a fault code according to the state data information when it is detected that the power supply unit has a fault. Functions fulfilled by the processor 4 may be installed onto the upper PC in the form of application software.

It can be understood that state words of the power supply unit 1 can reflect whether the power supply unit 1 is in a fault state or not, and the applicant of the present disclosure finds through multiple times of analysis and research that when the processor 4 monitors a plurality of state words of the power supply unit, the state words which are not changed in the whole process can be ignored, only the state words which are changed in the fault process are monitored, the monitoring range is gradually reduced, and it is determined that the PSU cannot maintain the fault state due to the fact that the BMC uses a fault clearing instruction, and the processing efficiency is improved.

In order to bring convenience for those skilled in the art to clearly understand the technical solution of the present application, the implementation process of the whole technical solution is described by taking an output overvoltage protection fault of the power supply unit as an example, an output overvoltage protection threshold of the PSU is set to be 12V through I2C, the PSU triggers protection immediately, an LED is changed from green normally-on to amber normally-on, and meanwhile, the fault type of the output overvoltage protection is reported to the BMC via the state words, and the following content may be included:

corresponding components such as a CPU, a memory and a hard disk are installed on a mainboard according to the configuration requirements of a server package; the jig is configured to connect the PSU with the mainboard; and an AC power supply is switched on, and the system is started up. The I2C bus led out by the jig is connected to the PC through the Microchip PICkit Serial Analyzer, and I2C communication software is started on the PC; and the I2C communication software is configured to fulfill the functions of the processor 4.

After setting of the output overvoltage protection threshold of the PSU is completed, the PSU triggers a fault, but a protection type uploaded to the BMC through the state words is wrong. The I2C communication software on the upper PC is set to cyclically read the state words of the PSU, the output overvoltage protection threshold of the PSU is modified through the BMC, and the output overvoltage protection of the PSU is triggered. On the upper PC, it can be seen that the output overvoltage fault is reported instantly by the state words of the PSU, and then a PS-OFF state is reported, and it can be determined that the fault reporting function of the PSU is normal, and abnormity appears in BMC information processing after fault reporting. After the fault cause is determined, BMC developers can be helped to check codes in a targeted manner, and finally solve the fault problem.

In the technical solution provided by an embodiment of the present disclosure, the power supply unit, the baseboard management controller, the jig and the processor are all connected to the I2C bus, so that normal communication between the power supply unit and the baseboard management controller is not influenced, and the processor may be configured to monitor the state of the power supply unit on the basis of not influencing communication between the power supply unit and the baseboard management controller; when the power supply unit has a fault, the fault code is located by collecting the state data information of the power supply unit, so that PSU testers can independently analyze BMC communication faults, and a targeted code checking direction is provided for the BMC developers, thus, the faults generated in the process of I2C communication between the BMC and the PSU are efficiently located, the debugging time is shortened, the participating manpower is reduced, and the fault solving efficiency can be effectively improved.

As a preferred implementation mode, in order to prevent abnormal situations such as power failure, and improve the reliability and stability of the whole system, after the fault code is located by the processor 4, the fault code and log information in the corresponding process can be packaged and output to a preset path, and the fault code is backed up at the same time. The corresponding process is a period of time when a fault is detected, for example, a PSU fault is detected at time t, the log information in the period of time from (t−10) s to (t+10) s and the fault code can be packaged at the same time to serve as a basis for querying fault causes, and the fault causes can be determined quickly and accurately.

Optionally, the processor 4 is further configured to call a pre-stored debug version set to parse the fault code to obtain a corresponding fault type; the debug version set includes a plurality of debug versions, and each debug version uniquely corresponds to one fault type. The debug version is a program written according to each fault type in advance, and the corresponding PSU fault type can be accurately detected by utilizing the debugging program. Of course, the user can test the fault types according to the requirements, and select the corresponding target debug version according to the required fault type; and the corresponding fault type is parsed by utilizing the target debug version, the system can directly output the current fault type of the PSU, and thus, workers can quickly determine the fault causes.

The embodiment of the present disclosure further provides a corresponding implementation method for the fault locating system based on I2C communication, and the method is further enabled to be more feasible. The fault locating method based on I2C communication provided by the embodiment of the present disclosure will be introduced below, and the fault locating method based on I2C communication described below and the fault locating system based on I2C communication described above may refer to each other correspondingly.

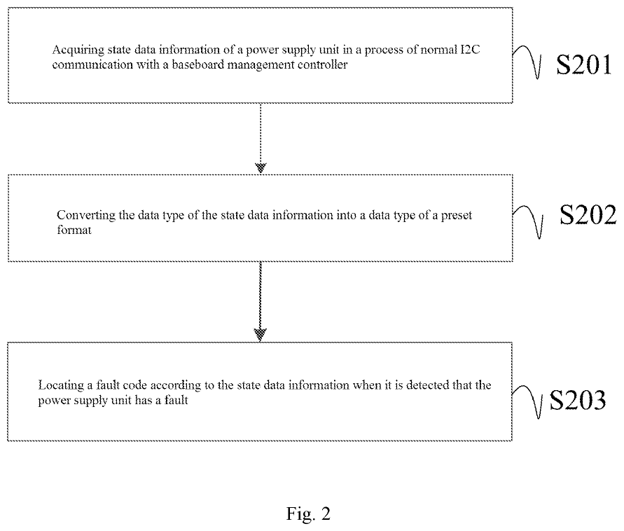

Referring to FIG. 2 firstly, FIG. 2 is a flowchart of a fault locating method based on I2C communication provided by the embodiment of the present disclosure, and the fault locating method is applied to a fault locating system that is based on I2C communication and includes a power supply unit, a baseboard management controller, a jig and a processor; the power supply unit is connected to the baseboard management controller through the jig, and the jig is connected to the processor through an I2C bus. The fault locating method in the embodiment of the present disclosure may include the following content:

S201: acquiring state data information of the power supply unit in a process of normal I2C communication with the baseboard management controller.

The state data information of the power supply unit is collected in the process of normal I2C communication between the power supply unit and the baseboard management controller, for example, the state data information of the power supply unit can be collected in a period when the power supply unit does not communicate with the baseboard management controller in a polling mode.

S202: converting the data type of the state data information into a data type of a preset format.

It can be understood that the format of the collected data information needs to be converted into a data format type which can be recognized or processed by the processor 4.

S203: locating a fault code according to the state data information when it is detected that the power supply unit has a fault.

Different state words represent current different states of the power supply unit, and when the state words having a fault are detected, it is determined that the power supply unit currently has a fault. The state of the PSU in the fault process is monitored, a code fault is located according to state presentation of the PSU, and state word monitoring in a steady running process of the PSU can further be achieved.

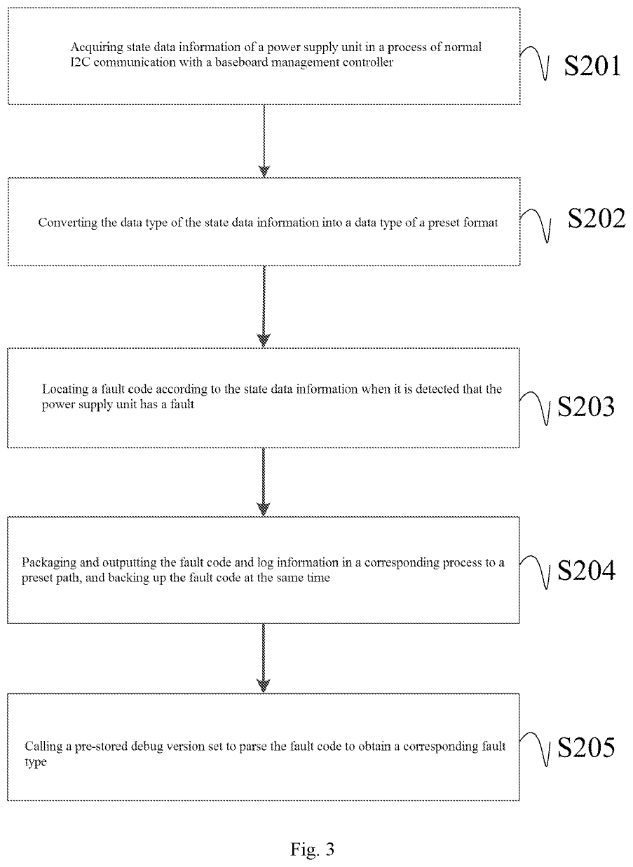

As an alternative implementation mode, referring to FIG. 3, and after S203 is implemented, the fault locating method may further include:

S204: packaging and outputting the fault code and log information in a corresponding process to a preset path, and backing up the fault code at the same time.

S205: calling a pre-stored debug version set to parse the fault code to obtain a corresponding fault type.

The debug version set includes a plurality of debug versions, and each debug version uniquely corresponds to one fault type.

In view of the above, it can be seen that in the embodiment of the present disclosure, the state of the PSU is monitored on the premise of not influencing the original communication between the BMC and the PSU through the configuration mode of I2Cs of multiple hosts, faults generated in the process of I2C communication between the BMC and the PSU can be located efficiently, debugging time is shortened, participating manpower is reduced, and the fault solving efficiency can be efficiently improved.

The embodiment of the present disclosure further provides a corresponding implementation apparatus for the fault locating method based on I2C communication, and the method is further enabled to be more practical. The fault locating apparatus based on I2C communication described below and the fault locating method based on I2C communication described above may refer to each other correspondingly.

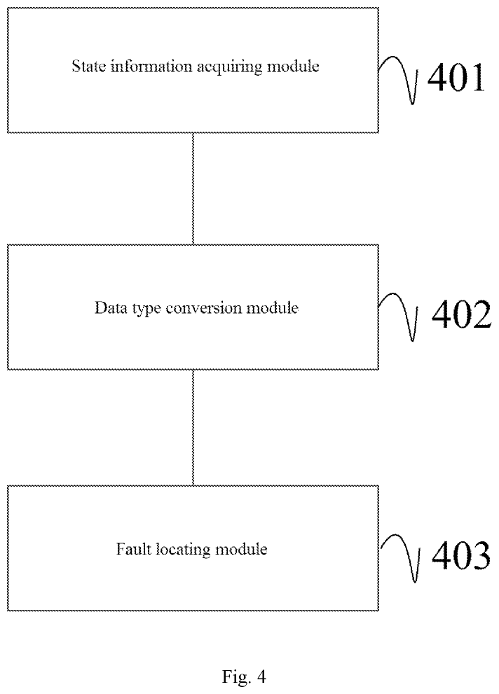

Referring to FIG. 4, FIG. 4 is a structure diagram of a fault locating apparatus based on I2C communication under a specific implementation mode according to an embodiment of the present disclosure, the fault locating apparatus based on I2C communication is applied to a fault locating system that is based on I2C communication and includes a power supply unit, a baseboard management controller, a jig and a processor; and the power supply unit is connected to the baseboard management controller through the jig, the jig is connected to the processor through the I2C bus, and the apparatus may include:

a state information acquiring module 401, configured to acquire state data information of the power supply unit in a process of normal I2C communication with the baseboard management controller;

a data type conversion module 402, configured to convert the data type of the state data information into a data type of a preset format; and

a fault locating module 403, configured to locate a fault code according to the state data information when it is detected that the power supply unit has a fault.

Optionally, in some implementation modes of the present embodiment, the fault locating module 403 may further be a module which is configured to detect, by monitoring changed state words in the state data information, whether the power supply unit is in a fault state or not.

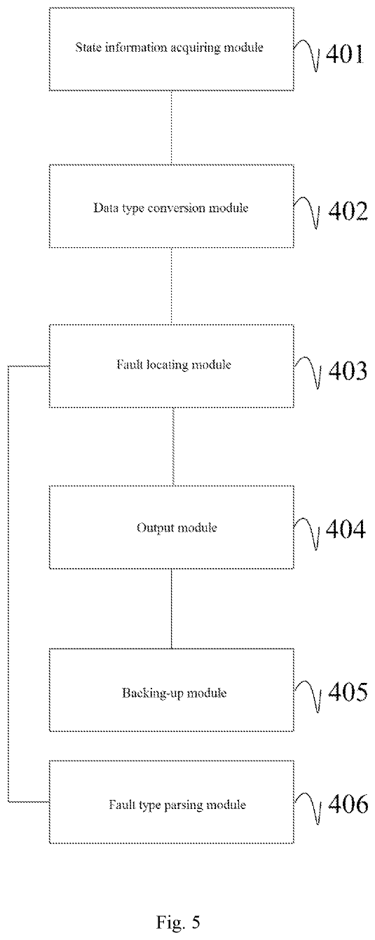

In some other implementation modes of the present embodiment, referring to FIG. 5, the apparatus, for example, may further include:

an output module 404, configured to package and output the fault code and log information in a corresponding process to a preset path;

a backing-up module 405, configured to back up the fault code; and

a fault type parsing module 406, configured to call a pre-stored debug version set to parse the fault code to obtain a corresponding fault type; wherein the debug version set includes a plurality of debug versions, and each debug version uniquely corresponds to one fault type.

The functions of the functional modules of the fault locating apparatus based on I2C communication according to the embodiment of the present disclosure may be specifically implemented according to the method in the foregoing method embodiment, and the specific implementation process may refer to the related description of the foregoing method embodiment, and will not be described here again.

In view of the above, it can be seen that in the embodiment of the present disclosure, the state of the PSU is monitored on the premise of not influencing the original communication between the BMC and the PSU through the configuration mode of I2Cs of multiple hosts, faults generated in the process of I2C communication between the BMC and the PSU can be located efficiently, debugging time is shortened, participating manpower is reduced, and the fault solving efficiency can be efficiently improved.

The embodiment of the present disclosure further provides fault locating equipment based on I2C communication, which may specifically include:

a memory, configured to store computer programs; and

a processor, configured to execute the computer programs to implement steps of the fault locating method based on I2C communication according to any one of the foregoing embodiments.

The functions of functional modules of the fault locating equipment based on I2C communication according to the embodiment of the present disclosure may be specifically implemented according to the method in the foregoing method embodiment, and the specific implementation process may refer to the related description of the foregoing method embodiment, and will not be described here again.

In view of the above, it can be seen that faults generated in the process of I2C communication between the BMC and the PSU can be located efficiently, debugging time is shortened, participating manpower is reduced, and the fault solving efficiency can be efficiently improved.

The embodiment of the present disclosure further provides a computer readable storage medium, which stores a fault locating program based on I2C communication, and when the fault locating program based on I2C communication is executed by a processor, the steps of the fault locating method based on I2C communication according to any one of the foregoing embodiments are implemented. The storage medium may be a USB flash drive, a mobile hard disk, a read-only memory, a random access memory, a magnetic disk or an optical disk and various other mediums which can store the program codes.

The functions of functional modules of the computer readable storage medium according to the embodiment of the present disclosure may be specifically implemented according to the method in the foregoing method embodiment, and the specific implementation process may refer to the related description of the foregoing method embodiment, and will not be described here again.

In view of the above, it can be seen that in the embodiment of the present disclosure, faults generated in the process of I2C communication between the BMC and the PSU can be located efficiently, debugging time is shortened, participating manpower is reduced, and the fault solving efficiency can be efficiently improved.

The various embodiments in this description are described in a progressive manner, and each embodiment focuses on differences from other embodiments, and the same or similar parts between the embodiments may refer to each other. The apparatus disclosed in the embodiment corresponds to the method disclosed in the embodiment, so that the description is simple, and the relevant points may refer to the description of the method part.

Professionals would further appreciate that the units and algorithm steps, described in connection with the embodiments disclosed herein, of various examples may be implemented as electronic hardware, computer software, or combinations of the electronic hardware and the computer software, and the components and steps of the various examples have been described above generally in terms of their functions in order to clearly illustrate interchangeability of hardware and software. Whether these functions are performed in hardware or software depends upon the particular application of the technical solution and design constraints. Skilled professionals can implement the described functions using different methods for each particular application, but such implementations should not be considered beyond the scope of the present disclosure.

The steps of a method or algorithm described in connection with the embodiments disclosed herein may be implemented directly in hardware, in a software module executed by a processor, or in a combination of the hardware and the software module executed by the processor. A software module may reside in a random access memory (RAM), a memory, a read-only memory (ROM), an electrically programmable ROM, an electrically erasable programmable ROM, a register, a hard disk, a removable disk, a CD-ROM, or any other form of storage medium known in the art.

The fault locating method, apparatus and system based on I2C communication provided by the present disclosure have been described in detail above. The principles and implementation modes of the present disclosure have been described herein using specific examples, and the foregoing embodiments are presented only to assist in understanding the method and its core concepts of the present disclosure. It should be noted that, for those skilled in the art, without departing from the principle of the present disclosure, it is possible to make various improvements and modifications to the present disclosure, and these improvements and modifications also fall within the scope of protection of the claims of the present disclosure.

1. A fault locating system based on I2C (Inter-Integrated Circuit) communication, comprising
a power supply unit, a baseboard management controller, a jig and a processor; wherein the power supply unit and the baseboard management controller are connected through the jig, and the jig is connected to the processor through an I2C bus; and
the processor is configured to acquire state data information of the power supply unit in a process of normal I2C communication with the baseboard management controller, convert the data type of the state data information into a data type of a preset format, and locate a fault code according to the state data information when it is detected that the power supply unit has a fault.

2. The fault locating system based on I2C communication according to claim 1, wherein, the processor is specifically configured to detect, by monitoring changed state words in the state data information, whether the power supply unit is in a fault state or not.

3. The fault locating system based on I2C communication according to claim 2, wherein, the processor is further configured to package and output the fault code and log information in a corresponding process to a preset path, and backup the fault code at the same time.

4. The fault locating system based on I2C communication according to claim 1, wherein, the processor is further configured to call a pre-stored debug version set to parse the fault code, so as to obtain a corresponding fault type; and the debug version set comprises a plurality of debug versions, and each debug version uniquely corresponds to one fault type.

5. A fault locating method based on I2C communication, applied to a fault locating system that is based on I2C communication and comprises a power supply unit, a baseboard management controller, a jig and a processor; the power supply unit and the baseboard management controller being connected through the jig, and the jig being connected to the processor through an I2C bus, the method comprising:
acquiring state data information of the power supply unit in a process of normal I2C communication with the baseboard management controller;
converting the data type of the state data information into a data type of a preset format; and
locating a fault code according to the state data information when it is detected that the power supply unit has a fault.

6. The fault locating method based on I2C communication according to claim 5, wherein, the step of locating a fault code according to the state data information when it is detected that the power supply unit has a fault comprises:
detecting, by monitoring changed state words in the state data information, whether the power supply unit is in a fault state or not.

7. The fault locating method based on I2C communication according to claim 5, wherein, after locating a fault code according to the state data information, the method further comprises:
packaging and outputting the fault code and log information in a corresponding process to a preset path, and backing up the fault code at the same time.

8. The fault locating method based on I2C communication according to claim 5, wherein, after locating a fault code according to the state data information, the method further comprises:
calling a pre-stored debug version set to parse the fault code to obtain a corresponding fault type; wherein the debug version set comprises a plurality of debug versions, and each debug version uniquely corresponds to one fault type.

9-10. (canceled)

11. The fault locating system based on I2C communication according to claim 2, wherein, the processor is further configured to call a pre-stored debug version set to parse the fault code, so as to obtain a corresponding fault type; and the debug version set comprises a plurality of debug versions, and each debug version uniquely corresponds to one fault type.

12. The fault locating system based on I2C communication according to claim 3, wherein, the processor is further configured to call a pre-stored debug version set to parse the fault code, so as to obtain a corresponding fault type; and the debug version set comprises a plurality of debug versions, and each debug version uniquely corresponds to one fault type.

13. The fault locating method based on I2C communication according to claim 6, wherein, after locating a fault code according to the state data information, the method further comprises:
calling a pre-stored debug version set to parse the fault code to obtain a corresponding fault type; wherein the debug version set comprises a plurality of debug versions, and each debug version uniquely corresponds to one fault type.

14. The fault locating method based on I2C communication according to claim 7, wherein, after locating a fault code according to the state data information, the method further comprises:
calling a pre-stored debug version set to parse the fault code to obtain a corresponding fault type; wherein the debug version set comprises a plurality of debug versions, and each debug version uniquely corresponds to one fault type.
